(19) United States
(12) Patent Application Publication
(10) Pub. No.: US 2026/0269643 A1
(43) Pub. Date: Sep. 10, 2026

(54) AN APPARATUS AND METHOD TO PROVIDE POWER TO ELECTRONIC LOADS AND FOR CHARGING ENERGY STORAGE DEVICES

(71) Applicant: ZERO-ERROR SYSTEMS PTE. LTD, Singapore (SG)

(72) Inventors: Wei SHU, Singapore (SG); Joseph Sylvester CHANG, Singapore (SG); Kwen Siong CHONG, Singapore (SG); Arunjai MITTAL, Singapore (SG)

(21) Appl. No.: 19/162,925

(22) PCT Filed: Mar. 8, 2024
(86) PCT No.: PCT/IB2024/052271

§ 371 Date: Sep. 5, 2025

(30) Foreign Application Priority Data
Mar. 8, 2023 (SG) 10202300625R

(51) Int. Cl. H02J 7/90; H02J 7/94; H02J 7/96

(52) U.S. Cl. CPC H02J 7/933; H02J 7/94; H02J 7/96; H02J 2207/20

(57) ABSTRACT

A device comprises at least one charging circuit, which comprises at least one input for connecting to at least one energy source, at least one output for connecting to at least one load and having an output voltage, and a controller configured to generate a control signal having an enabling signal portion, or a disabling signal portion, or both an enabling signal portion and a disabling signal portion, the and an output stage configured to, during the enabling signal portion, couple an inductor to the at least one input, or the at least one output, or both the at least one input and the at least one output, and during the disabling signal portion, isolate the inductor from the at least one input, or the at least one output, or both the at least one input and the at least one output.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Energy storage devices (e.g., lithium-ion battery) typically demand various charging phases: Trickle-charging phase, Pre-charging phase, Constant Current (CC) charging phase, and Constant Voltage (CV) charging phase. The different charging phases require different output currents/voltages. On the other hand, electronic loads often have a desired voltage supply range, and their voltage range may not match with the charging requirements for energy storage devices. In view of this, prior-art chargers require multiple control modes to cater for the needs of electronic loads and/or the different charging phases.

Examples of the prior-art includes U.S. Pat. Nos. 8,624,429 and 9,099,919. These prior-art teaches the following.

In a prior-art switched-mode charger 10 shown in FIG. 1, V_{IN} 11 and I_{IN} 12 are the input source voltage and the input source current, respectively. V_{SYS} 13 and I_{SYS} 14 are the output voltage and the output current to electronic load 194, respectively. C_{IN} 15, C_{SYS} 16 and C_{BAT} 17 are the input capacitor, the output capacitor for the electronic load(s), and the output capacitor for energy storage devices, respectively. V_{BAT} 31 and I_{BAT} 34 are the output voltage and current to energy storage devices 45, respectively. V_{DC} 190 and V_{BC} 191 are respectively the DC/DC control signal for output stage 192 and a battery-charging control signal for BATFET 193, the transistor which serves as a variable resistor.

FIG. 2 depicts an example of the prior-art output stage of a prior-art switched-mode charger 20. The output stage includes four switching devices, SW1 21, SW2 22, SW3 23 and SW4 24. These switching devices include, but are not limited to, transistors, diodes, etc. The output stage generates four control signals, V_{SW1} 25, V_{SW2} 26, V_{SW3} 27 and V_{SW4} 28, based on the control signal, V_{DC} 190, for respectively controlling the ‘ON’ and/or ‘OFF’ of the four switching devices, SW1 21, SW2 22, SW3 23 and SW4 24. FIG. 3 depicts the waveforms 30 of a prior-art switched-mode charger with a prior-art control methodology at different charging phases at two conditions: V_{IN}>V_{SYS} and V_{IN}>V_{BAT}, where V_{BAT} 31 is the battery voltage. When the energy storage device being charged is very weak (exhausted or near-exhausted), i.e., V_{BAT} 31 is lower than Threshold Voltage_1, V_{TH1} 32, the Trickle Charge mode is enabled; and V_{BAT} 31 is lower than V_{SYS_min} 33, which is the minimum supply voltage for the electronic load(s). V_{TH1} 32 is the manufacturer's recommended parameter for the energy storage device.

In the Trickle Charge mode, the prior-art switched-mode charger outputs a constant voltage, V_{SYS_min} 33, by the control of V_{DC} 190, which is generated by the DC/DC Controller. The charging current, I_{BAT} 34, is linearly controlled by V_{BC} 191 of the Battery Charger Controller via BATFET 193 at a constant k₁×I_{CHG}; where k₁<1 and I_{CHG} is the full charging current to the energy storage device. When V_{BAT} increases to be greater than Threshold Voltage_1, V_{TH1}, but lower than Threshold Voltage_2, V_{TH2} 35, the Pre-Charge mode is enabled. Note that V_{BAT} 31 is still lower than V_{SYS_min} 33.

In the Pre-Charge mode, the prior-art switched-mode charger still outputs the constant voltage, V_{SYS_min} 33, by the control of V_{DC} 190. The charging current, I_{BAT} 31 is linearly controlled by V_{BC} 191 of the Battery Charger Controller via BATFET 193, and is slightly higher than that in the Trickle Charge mode, i.e., the value of this higher current is now k₂×I_{CHG}; where k₁<k₂<1.

When V_{BAT} 31 increases to greater than Threshold Voltage_2, V_{TH2} 35, but lower than V_{SYS_min} 33, the Fast Constant Current (CC) Charge mode is enabled. In the CC Charge mode, the switched-mode charger still outputs the constant voltage, V_{SYS_min} 33, by the control of V_{DC} 190. The charging current, I_{BAT} is now charged at the maximum possible current, 100%×I_{CHG}−I_{SYS}, and is still linearly controlled by VBC 191 of the Battery Charger Controller via BATFET 193.

When V_{BAT} 31 increases to greater than V_{SYS_min} 33 but lower than the threshold voltage_3, VTH₃ 36, the energy storage device is still in the CC Charge mode. In this condition, the switched-mode charger outputs a constant maximum current having a value of 100%×I_{CHG}, by the control of V_{DC} 190, and BATFET 193 is fully turned-on. Now V_{SYS}=V_{BAT}, and I_{BAT}=100%×I_{CHG}-I_{SYS}.

When the energy storage device is almost full (fully-charged), i.e., V_{BAT} 31 is at or greater than Threshold Voltage_3, V_{TH3} 36, the Constant Voltage (CV) Charge mode is enabled. In this mode, the prior-art switched-mode charger outputs a constant maximum voltage, V_{MAX}, by the control of V_{DC} 190, and BATFET 193 is still fully turned-on.

In all charging modes in prior-art chargers, the control signal, V_{DC} 190, is a continuous analog signal, and is at slightly different levels for the Trickle Charge, Pre-Charge, Fast CC Charge and CV Charge modes, but is substantially constant during each of the different modes. In Trickle Charge, Pre-Charge, and the early part of Fast CC Charge modes, the control signal, V_{BC} 191, is also a continuous analog signal, and is a linear control of the resistance of BATFET 193, hence determining I_{BAT} 34. However, in the latter part of Fast CC Charge and in over the entire CV mode, the control signal, V_{BC} 191, is constant to fully turn on BATFET 193. The two control signals, V_{SW1} 37, V_{SW2} 38, V_{SW3} 39 and V_{SW4} 390 for turning on and off the switching devices, are generated in the output stage based on the level of the control signal V_{DC} 190. The control signals include pulses for alternately closing the switching devices. The pulse widths and/or periods of the control signals are dependent on the voltage level of the control signal, V_{DC} 190.

From FIG. 1, FIG. 2, and FIG. 3, it can be seen that the prior-art control methodology requires multiple controllers (with different design specifications) to achieve multiple charging modes and hence the pertinent charging requirements. Consequently, they suffer from four major shortcomings. First, the control methodology generally requires dedicated control circuitries for powering electronic loads and charging the energy storage device, hence requiring complicated hardware (e.g., requiring complex stability compensation). This leads to inevitable compromised dynamic performance at transitions from one charging mode to another, and electronic loads swings between low-to-high or high-to-low. Second, the power-efficiency of the control methodology varies substantially in different charging modes because the operations of the different charging modes are very different. Further, it is virtually impossible to optimize the power-efficiency across all charging modes as most, if not all, of the external components are shared amongst all charging modes. Third, the Bill of Materials (BOM) is high because the control methodology imposes strict requirements for the selection of discrete components (i.e., inductor and capacitor). Fourth, their form factor is large because the required inductor is relatively large and the compensation networks are complicated.

There is therefore a need for a switch-mode charging device which addresses, at least in part, one or more of the aforesaid shortcomings.

### SUMMARY

In an embodiment, a device is disclosed comprising at least one charging circuit. The at least one charging circuit comprises at least one input for connecting to at least one energy source, at least one output for connecting to at least one load and having an output voltage. The at least one charging circuit also comprises a controller configured to generate a control signal having an enabling signal portion, or a disabling signal portion, or both an enabling signal portion and a disabling signal portion. The enabling signal portion or the disabling signal portion is related to the output voltage. The at least one charging circuit further comprise an output stage configured to, during the enabling signal portion, couple an inductor to the at least one input, or the at least one output, or both the at least one input and the at least one output, and, during the disabling signal portion, isolate the inductor from the at least one input, or the at least one output, or both the at least one input and the at least one output.

In another embodiment, a method is disclosed for charging by a charging circuit having a first terminal connected to an energy source, a second terminal connected to an electronic load, a third terminal connected to an energy storage device, an inductor, and a controller. The method comprises generating, by the controller, a control signal related to the output voltage, to regulate the current in the inductor. The control signal has an enabling signal portion and a disabling signal portion. The method also comprises, during the enabling signal portion, coupling the first terminal via the inductor to the second terminal, the third terminal, or both the second terminal and the third terminal. The method further comprises, during the disabling signal portion, uncoupling the first terminal from the second terminal and the third terminal.

### BRIEF DESCRIPTION OF FIGURES

In order that the invention may be fully understood and readily put into practical effect, they shall now be described by way of non-limitative example only exemplary embodiments of the present invention, the description being with reference to the accompanying illustrative drawings.

FIG. 1 (prior-art) is a schematic diagram of a prior-art switched-mode charger with a control methodology.

FIG. 2 (prior-art) is an example of an output stage of the prior-art switched-mode charger in FIG. 1.

FIG. 3 (prior-art) is the operational waveforms of the prior-art switched-mode charger in FIG. 1.

FIG. 4 is a schematic diagram of a switched-mode charger having a (unified) controller and an output stage, that receives power from one energy source, according to an embodiment of the invention.

FIG. 5 is a schematic diagram of the control circuitry in FIG. 4.

FIG. 6 is a schematic diagram of the output stage in FIG. 4.

FIG. 7 shows waveforms of one operation of the switched-mode charger in FIG. 4.

FIG. 8 shows waveforms of another operation of the switched-mode charger in FIG. 4.

FIG. 9 shows waveforms of yet another operation of the switched-mode charger in FIG. 4.

FIG. 10 is a schematic diagram of a switched-mode charger that receives power from multiple external energy sources according to one of the embodiments of the invention.

FIG. 11 is a schematic diagram of the output stage in FIG. 10.

FIG. 12 is a schematic diagram of a switched-mode charger that receives power from multiple energy sources for powering multiple electronic loads and or charging multiple energy storage devices according to one of the embodiments of the invention.

FIG. 13 is a schematic diagram of a switched-mode charger having outputs of multiple chargers in FIG. 12 connected together according to one of the embodiments of the invention.

FIG. 14 is a schematic diagram of a switched-mode charger having multiple ports as either inputs or outputs coupled via an inductive coupler, and allowing bi-directional current flowing, according to one of the embodiments of the invention.

FIG. 15 is a schematic diagram of the output stage in FIG. 14 according to one of the embodiments of the invention.

FIG. 16 is a schematic diagram of a switched-mode charger, that receives power from an energy source for powering multiple output loads and charge an energy storage device, or receive power from the energy storage device for powering multiple output loads, according to one of the embodiments of the invention.

FIG. 17 is a schematic diagram of the output stage in FIG. 16 according to one of the embodiments of the invention.

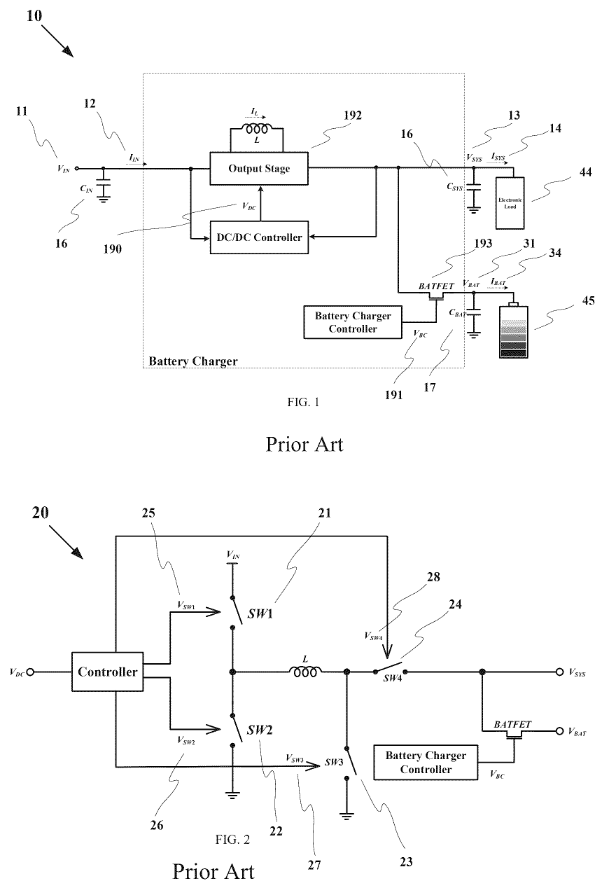

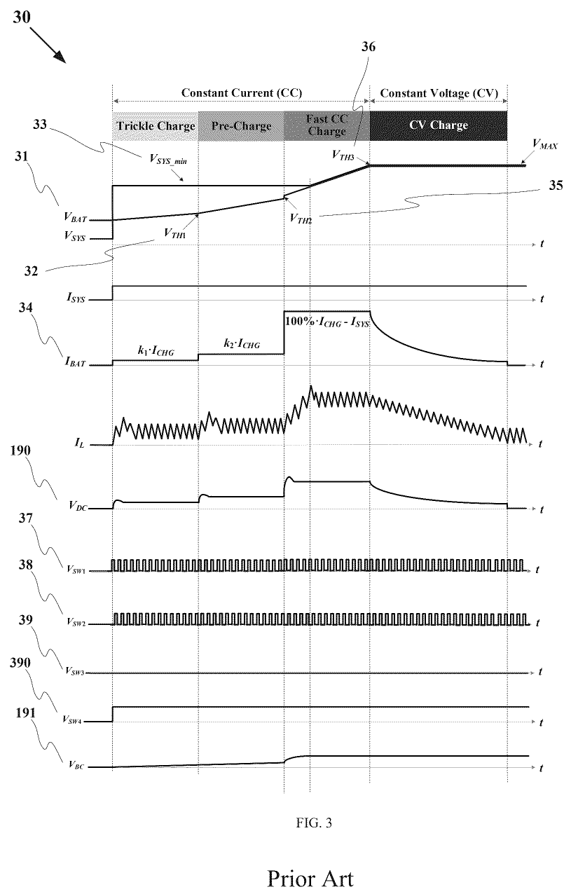

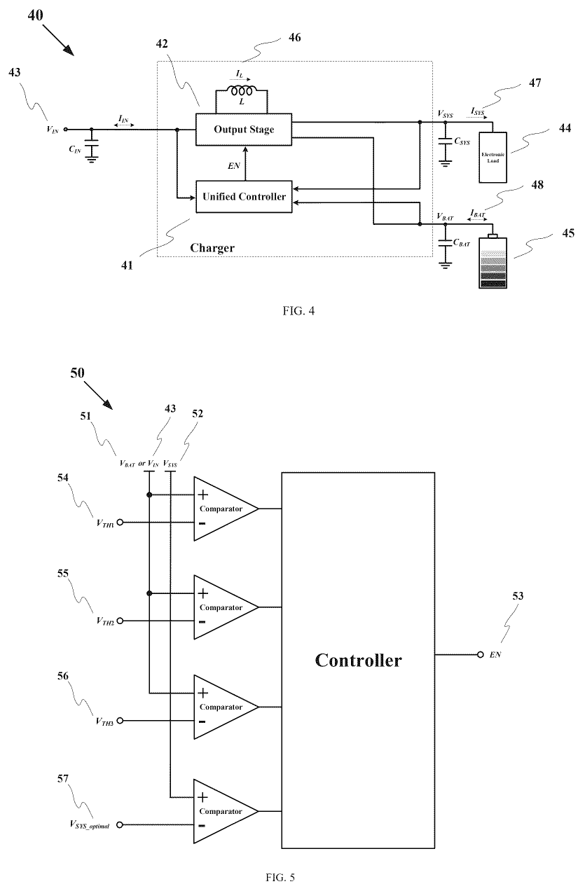

Other aspects and advantages of the invention will become apparent from the following detailed description, taken in conjunction with the accompanying drawings, illustrating by way of example the principles of the invention.

### DETAILED DESCRIPTION

Embodiments of the invention generally relate to an apparatus and a method to provide power to electronic loads and for charging energy storage devices. The embodiments also relate to an apparatus and a method for powering electronic loads over a constant voltage, and charging energy storage devices over a constant current charging phase and a constant voltage charging phase.

According to an aspect of the present disclosure, there is provided an apparatus that includes one or more charging circuits. Each charging circuit includes an input for connecting to an energy source, an output for connecting to an electronic load, a signal generator, and a switching circuit, and where pertinent, another output for connecting to another load (e.g., energy storage device). The signal generator is configured to generate a control signal that includes enabling (‘high’) and disabling (‘low’) signal portions that are based on or in some fashion related to an output voltage at the output. The switching circuit is configured to alternately charge and discharge the inductor during the enabling signal portions of the control signal, and to stop the inductor current during the disabling signal portions of the control signal.

In some embodiments, the control signal is set high for a first duration when the output voltage is lower than a first threshold voltage, and for a second duration when the output voltage is higher than the first threshold voltage. The length of the second duration may be longer or shorter than the first duration.

In some embodiments, the control signal is set high for the second duration when the output voltage is higher than the first threshold voltage and lower than a second threshold voltage, and for a third duration when the output voltage is higher than the second threshold voltage and lower than a third threshold voltage. The third duration may be close to or at all time.

In some embodiments, the third threshold voltage is close to or the same as the maximum voltage of the energy storage device, and the control signal is set low for a shorter duration when the output voltage equals to or exceeds the third threshold voltage.

In some embodiments, the width of each enabling signal portion corresponds to at least one cycle of coupling the output to the input and thereafter to ground.

In some embodiments, the device further comprises two or more input switches, wherein one of the input switches is configured to couple the input to the energy source, and each of the remaining input switches is configured to couple the input to another energy source (or another load or another energy source).

In some embodiments, the device alternatively or additionally includes two or more output switches. One output switch is configured to couple the output to the energy storage device. Each of the remaining output switches is configured to couple the output to an energy storage device (or another load or another energy source, or another energy storage device).

In some embodiments, the device includes two or more input switches. One input switch is configured to couple the input to the energy source. Each of the remaining input switches is configured to couple the input to another energy source (or another load or another energy storage device).

In some embodiments, the device comprises two or more charging circuits having respective outputs that are in some form coupled together, and having respective inputs that are also in some form coupled together.

In some embodiments, the device comprises three or more switching circuits and a (unified) controller having multiple input or output ports coupled together via an inductive coupler. One or more of the switching circuits operate to alternatively charge or discharge the inductive coupler during the enabling signal portions of the control signal, hence transferring the energy from one or more inputs to one or more outputs or vice-versa (from one output to an input, etc.); and stopping the inductor current during the disabling signal portions of the control signal.

In some embodiments, the switching circuit operates under a first operation mode to alternately charge and discharge an inductor, hence transferring the energy from the input to the output during the enabling signal portions of the control signal; and stopping the inductor current during the disabling signal portions of the control signal. The switching circuit is further configured, under a second operation mode, to alternately charge and discharge an inductor, hence transferring the energy from the output to the input during the enabling signal portions of the control signal; and stopping the inductor current during the disabling signal portions of the control signal.

According to another aspect of the present disclosure, there is provided a method of powering an electronic load and charging an energy storage device. The method includes generating a control signal that includes enabling and disabling signal portions that are based on or in some form related to the respective voltages of the requirement of the electronic load and the energy storage device. This method alternately charges and discharges an inductor, hence coupling the energy from the energy source to the energy storage device during the enabling signal portions of the control signal; and stopping the inductor current, hence isolating the energy storage device from the energy source during the disabling signal portions of the control signal.

In some embodiments, the energy source is at least one energy source selectable from a multiple of energy sources. Further, the energy source may be replaced by an electronic load or an energy storage device.

In some embodiments, the energy storage device is at least one energy storage device selectable from a multiple of energy storage devices. Further, the energy storage device may be replaced by an electronic load or an energy source.

In some embodiments, the (electronic) load is at least a load selectable from a multiple of loads. Further, the load may be replaced by an electronic storage device or an energy source.

In some embodiments, the energy source outputs a voltage, a current or both voltage and current, and the energy storage device receives a voltage, a current or both voltage and current.

In some embodiments, there are charging and discharging an inductor, hence coupling the energy from the energy source(s) to the energy storage device(s) and/or electronic load(s), and vice-versa, during the enabling signal portions of the control signal; and stopping the inductor current, hence isolating the energy source from the others during the disabling signal portions of the control signal under one operation mode. The method, under another operation mode, further includes alternately coupling the energy from one energy storage device to another one or more energy storage devices during the enabling signal portions of the control signal; and stopping the inductor current hence isolating the energy storage device from other the energy source during the disabling signal portions of the control signal. The method, under yet another operation mode, further includes alternately coupling the energy from the energy storage device to the electronic loads during the enabling signal portions of the control signal; and stopping the inductor current, hence isolating the energy storage device from the electronic loads during the disabling signal portions of the control signal.

This summary does not describe an exhaustive list of all aspects of the present invention. It is anticipated that the present invention includes all methods, apparatuses and systems that can be practiced from all appropriate combinations and permutations of the various aspects in this summary, as well as that delineated below. Such combinations and permutations may have specific advantages not specially described in this summary.

Exemplary embodiments of the control methodology or circuitry for the switched-mode charger in this disclosure will be described below with reference to FIGS. 4 to 17 below. Numerous specific details are set forth in the following description. It is however understood that embodiments of the invention may be practiced with or without these specific details. In other instances, circuits, structures, methods and techniques that are known are not included so as to avoid obscuring the understanding of this description. Furthermore, the following embodiments of the invention may be described as a process, which may be described as a flowchart, a flow diagram, a structure diagram, or a block diagram. The operations in the flowchart, flow diagram, structure diagram or block diagram may be a sequential process, parallel or concurrent process, and the order of the operations may be re-arranged. A process may correspond to a technique, methodology, procedure, etc.

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Throughout the description, it is to be appreciated that the term ‘controller’ and its plural form include microcontrollers, microprocessors, programmable integrated circuit chips such as application specific integrated circuit chip (ASIC), computer servers, FPGAs, electronic devices, and/or combination thereof capable of processing one or more input electronic signals to produce one or more output electronic signals. The controller includes one or more input modules and one or more output modules for processing of electronic signals.

Unless defined otherwise, all technical and scientific terms used herein have the same meaning as is commonly understood by a skilled person to which the subject matter herein belongs.

As shown in the drawings for purposes of illustration, the invention may be embodied in a novel device and method for charging an energy storage device, such as a battery. Existing devices tend to be complicated and costly. Referring to FIGS. 4-17, a device embodying the invention generally includes one or more charging circuits. Each charging circuit includes an input (or more inputs) for connecting to an energy source (or load or energy storage device), an output (or more outputs) for connecting to an energy storage device (or load or an energy source), a signal generator and a switching circuit. The signal generator is configured to generate a control signal that includes enabling and disabling signal portions that are based on or in some fashion related to an output voltage of the output. The switching circuit is configured as an output stage to alternately charge and discharge an inductor during the enabling signal portions of the control signal, and to stop the inductor current during the disabling signal portions of the control signal. The device may be a charging device, an integrated circuit, a module, or a printed circuit board, etc.

This invention offers many advantages over the prior-art. First, it features higher power efficiency across all different outputs, including voltage outputs, e.g. electronic loads, and current outputs, e.g. battery. Second, it allows faster transition between different outputs without cross coupling. Third, it provides faster response to dynamic loading demand.

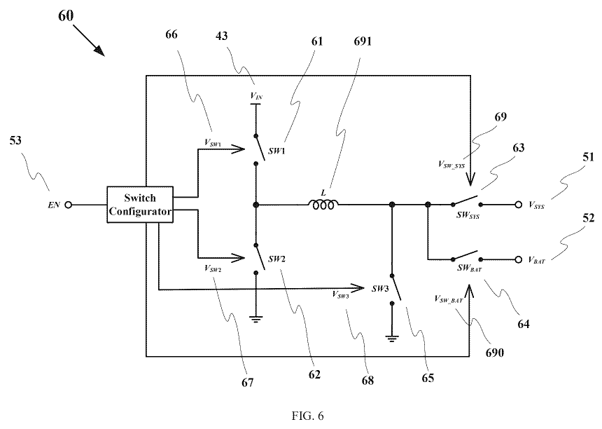

Specifically, FIG. 4 depicts a switched-mode charger 40 according to a first exemplary embodiment, with the control methodology, configured to have a signal generator or (unified) controller 41, a switching circuit (60 in FIG. 6) in output stage 42, an input port, V_{IN} 43, for connecting to one of an energy source, and having two output ports, one connecting to an electronic load 44 and the other connecting to an energy storage device 45, typically a battery.

FIG. 5 depicts the components 50 of the (unified) controller 41 and FIG. 6 depicts the components of the output stage 42 and two switches, SW_{SYS} and SW_{BAT}, of the present invention. The unified controller 41 receives both output voltages, V_{SYS} 51 and V_{BAT} 52, —see FIG. 4—and generates a control signal EN 53. This control signal, EN 53, includes enabling signal portions and disabling signal portions. In this embodiment, an enabling signal portion has a high voltage level while a disabling signal portion has a lower voltage (including zero voltage) level; other signal representation is also possible, e.g., higher current and lower current, respectively. However, the reverse is also possible, i.e., an enabling signal portion may be of a lower voltage level while the disabling signal portion may be of a higher voltage level. In FIG. 5, the duration of the control signal, EN 53, set high is given by a width of the enabling signal portion—note that any signal representation form may be possible. In other words, the (unified) controller 41 outputs ‘Enable’ or ‘Disable’signals. This is different from the prior-art delineated earlier.

The output stage 42 in FIG. 4 operates differently at three different conditions:
First condition: V_{IN} 54 is substantially greater (e.g., at least 20% greater) than V_{SYS} 52 or V_{BAT} 51,
Second condition: V_{IN} 54 is close to V_{SYS} 52 or V_{BAT} 51, and
Third condition: V_{IN} 54 is substantially lower (e.g., at least 20% lower) than V_{SYS} 52 or V_{BAT} 51.

In the first condition, when the control signal EN 53 is ‘Enable’ (enabled), the output stage 42 alternately couples an output, via an inductive element such as, but not limited to, an inductor L 691, to an input and ground. In this enabled state, the output(s) of the output stage 42 are either connected to ground by the closing of a switching device, SW2 62, or to V_{IN} 43, a DC (or near-DC, DC-like, or with some equivalent DC) energy source or power supply (or energy storage device), by closing a switching device, SW1 61; the switching device, SW3 65, is always open, and one or both of two switching devices, SW_{SYS} 63 and SW_{BAT} 64 is always closed. The switching devices include, but are not limited to, transistors, MOSFETS, diodes, or the like known to those skilled in the art. When the control signal, EN 53, is ‘Disable’ (disabled), the output stage 41 isolates the outputs, V_{SYS} 52 and V_{BAT} 51, from the input and ground by opening all switching devices, SW1 61, SW2 62, SW3 65, SW_{SYS} 63 and SW_{BAT} 64.

In the second condition, when the control signal, EN 53, is ‘Enable’ (enabled), the output stage 42 alternately couples an input, via an inductive element such as, but not limited to, an inductor L 691, to ground, and via the inductive element, to an output. In this enabled state, the outputs of the output stage 42 are connected to ground by closing the switching device, SW2 62, and closing one or both of the switching devices, SW_{SYS} 63 and SW_{BAT} 64, and V_{IN} 43 is connected to ground via the inductor, 691, by the closing of both switching devices SW1 61 and SW3 65. When the control signal EN 53 is ‘Disable’ (disabled), the output stage 42 reduces (including stopping) the current into the outputs, V_{SYS} 52 and V_{BAT} 51, from the input and the ground by opening all switching devices, SW1 61, SW2 62, SW3 65, SW_{SYS} 63 and SW_{BAT} 64.

In the third condition, when the control signal, EN 53, is ‘Enable’ (enabled), the output stage 42 alternately couples an input, via the inductive element such as, but not limited to, an inductor L 691, to ground. In this enabled state, V_{IN} 43 is connected to the outputs of the output stage 42 by closing switching device, SW1 61, and closing one or both of the switching devices, SW_{SYS} 63 and SW_{BAT} 64, and connected to ground via the inductive element by closing the switching device SW1 61 and SW3 65. When the control signal EN 53 is ‘Disable’ (disabled), the output stage 42 reduces (including stopping) the current into the outputs, V_{SYS} 52 and V_{BAT} 51, from the input and ground by opening all switching devices, SW1 61, SW2 62, SW3 65, SW_{SYS} 63 and SW_{BAT} 64.

In the ‘Enable’ state, the output stage 42 operates at a high or the maximum (or near-maximum) power-efficiency point to the output current and/or voltage to power electronic loads 44 and to charge the energy storage device 45. Conversely, in the ‘Disable’ state, the output stage 42 outputs low (including zero or near-zero) current and/or voltage to the power electronic loads 44 and to charge the energy storage device 45. The ratio of the ‘Enable’and ‘Disable’largely determines an actual output current and/or voltage.

FIG. 5 depicts a block diagram embodiment of the control methodology or (unified) controller 41. The (unified) controller 41 receives the voltages, V_{IN} 43, V_{SYS} 52 and V_{BAT} 51. Depending on the system requirements, there could be many different configurations for the signal processing of the received voltages, V_{IN} 43, V_{SYS} 52 and V_{BAT} 51. The embodiment in FIG. 5 compares V_{BAT} 51 or V_{IN} 43 with three threshold voltages, VTH1 54, V_{TH2} 55 and V_{TH3} 56 using three respective comparators, and compares V_{SYS} 52 with V_{SYS_optimal} 57 using one comparator. The threshold voltages V_{TH1} 54, V_{TH2} 55 and V_{TH3} 56 are typically determined by a manufacturer of the energy storage device, and the V_{SYS_optimal} 57 is typically determined by a manufacturer of electronic loads. Based on the outputs of these four comparators, a generator generates the control signal EN 53. The control signal EN 53 may be an analogue, a digital, a mixed-analog-digital, or a time-based signal. Depending on the specific type of signal, for example if the control signal EN 53 is an analog signal, the enabling signal portions and the disabling signal portions may be of different voltage levels as described above. The duration of control signal EN 53 set high is tuned so as to produce the actual output current or voltage required in the different charging phases. Depending on the design, it is also possible that control signal EN 53 produces an output that is in some fashion related (i.e., not necessarily the actual output current or voltage) to the actual output current or voltage required in the different charging phases.

The schematic drawing in FIG. 5 shows one way of implementing the control methodology or unified controller circuitry. There are other ways of implementing the control circuitry. For example, V_{IN} 43 can be compared with one or more different references using additional comparator(s). As another example, the comparison and the ensuing controller in FIG. 5 can be implemented using a microcontroller in digital (e.g., a digital inverter with sampling), mixed-signal, or time-based realization instead of the analog realization shown in FIG. 5.

FIG. 6 depicts one embodiment of the output stage 42 in FIG. 5 of the present invention, wherein switching devices SW1 61, SW2 62, SW3 65, SW_{SYS} 63 and SW_{BAT} 64 can be implemented using any switching devices such as, but not limited to, transistors, diodes, etc. Based on the control signal, EN 53, received, the output stage 42 generates five control signals V_{SW1} 66, V_{SW2} 67, V_{SW3} 68, V_{SW_SYS} 69, and V_{SW_BAT} 690, for turning ‘ON’ and ‘OFF’ the five switching devices, SW1 61, SW2 62, SW3 65, SW_{SYS} 63 and SW_{BAT} 64. Note that these five control signals may be analog, digital, mixed-signal, time-based signal, etc.

Unlike the control signal V_{DC} 190 in prior-art FIG. 1, the control signal, EN 53, in FIG. 6 is a digital signal in one or more of the charging phases. Note that this signal may also be analog, mixed-signal, time-based, etc., but is presently described as digital for sake of illustration—the imperative consideration is the functionality of the signal. When the control signal, EN 53, is at (or equivalent to) a high voltage level, the output stage of the switched-mode charger 40 is enabled, wherein the switch configurator produces pulses for alternately turning on and off the five switching devices SW1 61, SW2 62, SW3 65, SW_{SYS} 63 and SW_{BAT} 64.

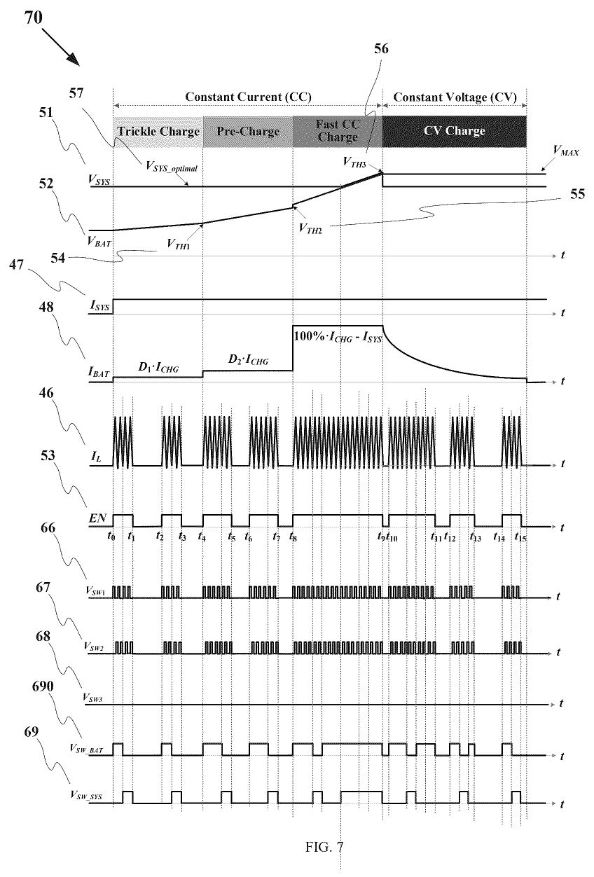

The switch configurator can be implemented in many ways known to those skilled in the art. One possible implementation is to use combinational logic, such as logic AND gates (not shown), with the control signal, EN 53, functioning as a gating signal at an input thereof to obtain the five control signals, V_{SW1} 66, V_{SW2} 67, V_{SW3} 68, V_{SW_SYS} 69, and V_{SW_BAT} 690, at the outputs of the logic AND gates. The pulse width of the control signal EN 53 is determined in some relation (including directly) to on a peak value of an inductor current, I_{L} 46, or based on a signal resembling the peak value. The pulses define the five control signals, V_{SW1} 66, V_{SW2} 67, V_{SW3} 68, V_{SW_SYS} 69, and V_{SW_BAT} 690. The width of each enabling signal portion (of EN 53) corresponds to at least one charging cycle. FIG. 7 depicts the waveforms of one operation of the switched-mode charger 40 in FIG. 4 where the width of the enabling signal portion (of EN 53) in the Trickle Charge phase corresponds to two charging cycles when V_{SW_BAT} is ‘high’. The width of the enabling signal portion in the Pre-Charge phase corresponds to two cycles as shown when V_{SW_BAT} 690 is ‘high’ in FIG. 7. When the control signal, EN 53, is low, the output stage of the switched-mode charger 40 is disabled, and the switch configurator turns ‘OFF’ all the switching devices SW1 61, SW2 62, SW3 65, SW_{SYS} 63 and SW_{BAT} 64 so that the outputs are isolated from the input and the ground.

Again, FIG. 6 shows only one way of implementing the output stage 42 and the interconnections with the inductor, L 691. Depending on the applications and requirements, the output stage 42 can be realized with more or fewer switching devices, and the interconnections between the switching devices and the inductor, L 691 may have many variations known to those skilled in the art.

FIG. 7 depicts the waveforms 70 of the first exemplary embodiment of the switched-mode charger 40 in FIG. 4 with the control methodology or (unified) controller 41, wherein an energy source at V_{IN} 43 powers the electronic load 44 and charges the energy storage device 45 at the condition of V_{IN} 43 is greater than V_{SYS} 52 or V_{BAT} 51. As described above, when the control signal, EN 53, is high, the output stage 42 of the switched-mode charger 40 is enabled. When the control signal, EN 53, is low, the output stage 42 of the switched-mode charger 40 is disabled. When the control signal, EN 53, is high, the inductor current, I_{L} 46, increases from zero (or a low value) to the predetermined peak current and then back to zero (or a low value) in accordance with the pulses of the control signals. The predetermined peak inductor current I_{L}, 46, is a fixed current for all charging phases shown in FIG. 7. However, this is not to be construed to be limited as such. The peak current may be adaptive and hence vary across different charging phases. For example, the peak current can be set to a high value for high-current charging modes (e.g., Fast CC) and to a low value for low-current charging modes (e.g., Trickle Charge, Pre-Charge, CV Charge).

The charging operation in FIG. 7 will now be described in detail. When the energy storage device 45 is very weak, i.e., near-exhaustion or is exhausted, V_{BAT} 51 is lower than the Threshold Voltage_1, V_{TH1} 54, (a manufacturer recommended parameter for the energy storage device), and the Trickle Charge mode is enabled. Note that V_{BAT} 51 is also lower than V_{SYS_optimal} 57, the optimal supply voltage for electronic load(s) 44. In the Trickle Charge mode, when EN 53 is high, I_{L} 46 generates two operating cycles for V_{BAT} 51 and V_{SYS} 52 respectively. Note that the specific number of operating cycles for V_{SW_SYS} 69 is to derive V_{SYS}=V_{SYS_optmial}, while the specific number of operating cycles for V_{SW_BAT} 690, on the other hand, is to derive I_{BAT}=D₁×I_{CHG}, where D₁<1 and I_{CHG} is the full or near-full charging current. In other words, the two operating cycles are only an example, and there may instead be a different number of cycles.

When the energy storage device is slightly charged or not quite exhausted, V_{BAT} 51 increases to greater than Threshold Voltage_1, V_{TH1} 54, but lower than Threshold voltage_2, V_{TH2}, the Pre-Charge mode is enabled. Note that V_{BAT} is still lower than V_{SYS_optimal} 57. In the Pre-Charge mode, when EN 53 is high for a longer period than in the Trickle Charge mode, there are more I_{L} 46 operating cycles. As the I_{SYS} 47 remains the same as that in the Trickle Charge mode, the number of operating cycles for V_{SYS} 51 is still two. On the other hand, as the charging current is higher, the number of operating cycles for V_{BAT} 51 increases to four. Note that the number of operating cycles for V_{SW_SYS} 69 is to derive V_{SYS}=V_{SYS_optmial}, and the number of operating cycles for V_{SW_BAT} 690 is to derive I_{BAT}=D₂×I_{CHG}, where D₁<D₂<1. As before, the number of operating cycles are only an example, and there may instead be a different number of cycles.

When VBAT increases to greater than Threshold Voltage_2, V_{TH2} 55, but lower than V_{SYS_optimal} 57, the Fast Constant Current (CC) Charge mode is enabled. In the Fast CC Charge mode, as EN 53 is continuously high (and high for a longer period than both the Trickle Mode and the Pre-Charge Mode), the operating cycles of I_{L} 46 is continuous without pause. The specific number of operating cycles for V_{SW_SYS} 69 is to derive V_{SYS=}V_{SYS_optmial}, and the number of operating cycles for V_{SW_BAT} 690 ascertains that I_{BAT}=100% ×I_{CHG}−I_{SYS}.

When electronic load(s) 44 is very low, I_{SYS} 47 is near zero, the energy storage device is charged at the maximum or near-maximum rate, i.e., I_{BAT}=100%×I_{CHG}. When V_{BAT} increases to greater than V_{SYS_optimal} 57 but lower than Threshold Voltage_3, V_{TH3} 56, the energy storage device is still in the CC Charge mode. In this condition, EN 53 is still continuously high, and both SW_{SYS} 63 and SW_{BAT} 64 are continuously turned. Hence, V_{SYS} =V_{BAT}, and I_{BAT}=100%×I_{CHG}−I_{SYS}.

When the energy storage device is almost full (fully-charged), i.e., V_{BAT} 51 is at or greater than Threshold Voltage_3, V_{TH3} 56, the Constant Voltage (CV) Charge mode is enabled. In this mode, the duration of EN 53 at high is adaptively adjusted so as to maintain V_{SYS}=V_{SYS_optimal} and V_{BAT}=V_{MAX}. In FIG. 7, the duration of EN 53 set high may be shorter in this CV charge phase.

Again, FIG. 7 shows only one condition when V_{IN} 43 is greater than V_{SYS} 52 and V_{BAT} 51. For other conditions, e.g., V_{IN} 43 is close to V_{SYS} 52 and/or V_{BAT} 51, and V_{IN} 43 is lower than V_{SYS} 52 and/or V_{BAT} 51, the switched-mode charger 40 may have the control signal, EN 53, with a varied duration at high. Consequently, the five controls signals, V_{SW1} 66, V_{SW2} 67, V_{SW3} 68, V_{SW_SYS} 69 and V_{SW_BAT} 690 may also be of different variations, and this is generally known to those skilled in the art.

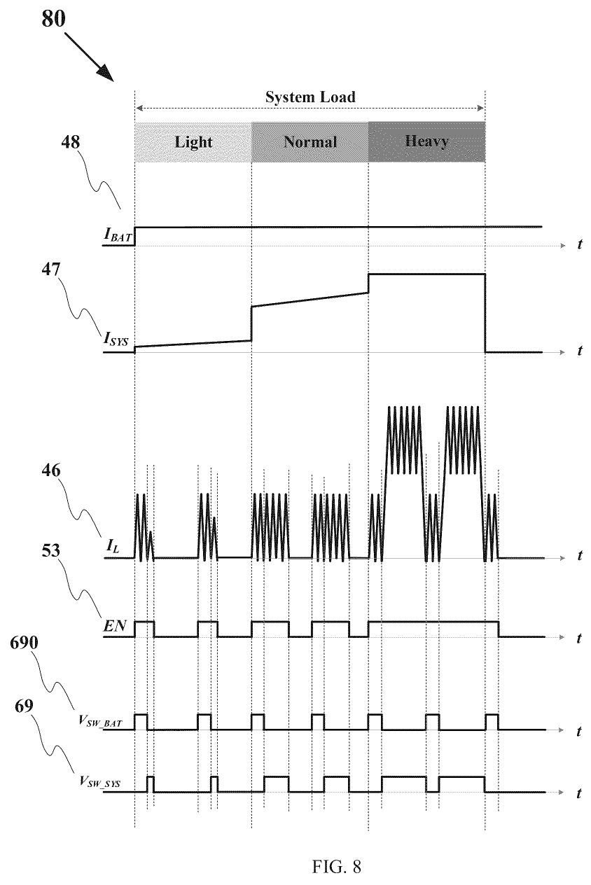

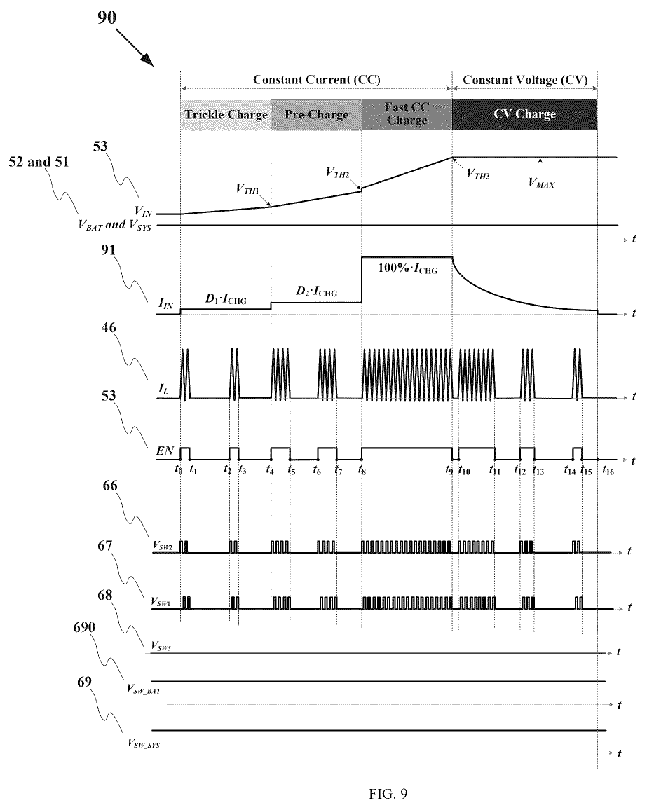

FIG. 8 also depicts the waveforms 80 of another first exemplary embodiment of the invention (see FIG. 4 for connections) involving a switched-mode charger with control methodology or (unified) controller (another first exemplary embodiment is given in FIG. 9) where an energy source at V_{IN} 43 powers an electronic load 44 at V_{SYS} 51 and charges an energy storage device 45 at V_{BAT} 52. Unlike FIG. 7, the electronic load at V_{SYS} 51 considered may be a light load, normal load, or a heavy load.

At light electronic load, the electronic load 44 draws low current from the energy source at VIN 43. When V_{SW_SYS} 69 is high, the energy source at V_{IN} 43 delivers low power to the electronic load. The inductive current, I_{L} 46 (FIG. 4), in inductor 691 (FIG. 6) is adaptively controlled such that the peak of I_{L} 46 is adaptive to the required electronic load current, I_{SYS} 47, and its valley of I_{L} 46 returns to zero (or a low value) at every discharge cycle. In this manner, the voltage ripple at V_{SYS} 52 is kept low.

At normal electronic load, the electronic load 44 draws normal current (higher than at light electronic load) from the energy source at V_{IN} 43. When V_{SW} sys 69 is high, the energy source at V_{IN} 43 delivers normal power to the electronic load 44, and the inductive current, I_{L} 46, is controlled such that the peak of I_{L} 46 is usually largely fixed (or may be variable) at an optimized value, and its valley of I_{L} 46 returns to zero (or a low value) at every discharge cycle. As I_{SYS} 47 increases, the number of charging-discharging cycles increases. In this manner, optimized (or near-optimized) power-efficiency is achieved.

At high electronic load, the electronic load 44 draws high current (higher than at both light load and normal load) from the energy source at V_{IN} 43. When V_{SW_SYS} 69 is high, the energy source at V_{IN} 43 delivers high power to the electronic load 44, and the inductive current, I_{L} 46, is adaptive controlled such that both the peak and the valley of I_{L} 46 are adaptive to I_{SYS} 47, i.e. both the peak and valley are variable. In this manner, both low voltage ripple at I_{SYS} 52 and optimized (or near-optimized) power-efficiency are achieved.

FIG. 9 depicts the waveforms 90 of yet another first exemplary embodiment of the invention. This yet another first exemplary embodiment (see FIGS. 4 and 6 for connections) involves a switched-mode charger with the control methodology or (unified) controller, wherein a first energy storage device at the output, V_{BAT} 52, powers an electronic load at V_{SYS} 51 and charges a second energy storage device connected to the input, V_{IN} 43, at the condition that the voltage of the energy storage device at the input, V_{IN} 43 is greater than V_{SYS} 51 and V_{BAT} 52. Note that this is possible because the invented battery charger now involves boost converter/conversion.

With reference to FIG. 6, the switching devices, SW_{BAT} 64 and SW_{SYSY} 63 are at all times (or mostly) closed, and the switching device, SW3 65, is open (or mostly open). Hence, V_{SYS}=V_{BAT}, and the first energy storge device at the output at V_{BAT} 52, powers the electronic load V_{SYS} 51 directly without conversion. Meanwhile, as described for FIG. 7, the control signal EN 53 is set to high according to the pertinent charging modes, i.e., Trickle Charge, Pre-Charge, Fast CC Charge, and CV Charge modes, and this is in part determined by Threshold Voltage_1, V_{TH1} 54, the voltage of the second storage device at V_{IN} 43 that is specified by the manufacturer of the second energy storage device at the input, V_{IN} 43. The number of operating cycles of I_{L} 46 in these different charging modes are different in these different charging modes.

Note that FIG. 9 shows only an example of one energy storage device connected to V_{IN} 43. Depending on the applications and requirements, a load (or energy source as delineated earlier) instead of an energy storage device can also be connected to V_{IN}. The ensuing variations of the operation of all pertinent control signals are known to those skilled in the art.

In all modes from FIGS. 4-9, when powering electronic loads, I_{SYS}, generally has a higher priority than charging the energy storage device, I_{BATPK .}

In all modes from FIGS. 4-9, the peak inductor current may vary in different phases for charging the energy storage device(s) and/or powering the electronic load. Further, the peak inductor current may be adaptive or variable instead of being fixed.

### In all modes from FIGS. 4-9, the valley of the inductor current may be regulated at a positive value above zero.

It can be seen from FIGS. 4-9 that the output stage 42, when ‘Enabled’, features the Boundary Conduction operation (by means of the control methodology or (unified) controller 41) across most of charging modes. In view of this, the power-efficiency of the switched-mode charger 40 can be optimized (or near optimized) for all charging modes, and inherent stability can be easily achieved. Further, the charging mode transition is seamlessly controlled by the one bi-level control signal, EN 53, for all four charging modes vis-à-vis an analog (or variable valued) control signal in the prior-art.

By leveraging on the control methodology (or (unified) controller 41) and the ensuing operation, the power efficiency of the switched-mode charger 40 can be further enhanced by realizing fully soft-switching, i.e., Zero-Current-Switching (ZCS) and/or Zero-Voltage-Switching (ZVS). Fully (or near fully) soft-switching is possible in the switched-mode charger 40 as the I_{L} always decreases to zero (or near zero) for every (or most) switching cycle (where pertinent), hence achieving ZCS and/or ZVS for most, if not all, switching devices, SW1 66, SW2 67, SW3 65, SWsys 63 and SWBAT 64.

The power source at the input can be an energy harvester, e.g., solar panel. Hence, the switched-mode charger 40 with the control methodology or (unified) controller 41 can also operate at the Maximum Power Point Tracking (MPPT) mode, and this can be achieved by tuning the duration of control signal EN 53 at high accordingly.

The actual charging current obtainable can be adjusted by changing the peak current, I_{L}, and the pertinent ratios, D₁ and D₂.

The control methodology offers two additional merits over prior-art methods. First, the control methodology alleviates the requirements of discrete components in view of the ‘Enable’ and ‘Disable’ bi-level control signal. Hence, the cost of the discrete components can be several times lower than those used in the prior-art charger depicted in FIG. 1. Second, the form factor of the switched-mode charger 40 can be much smaller due to the simpler hardware and reduced/relaxed requirements for the discrete components.

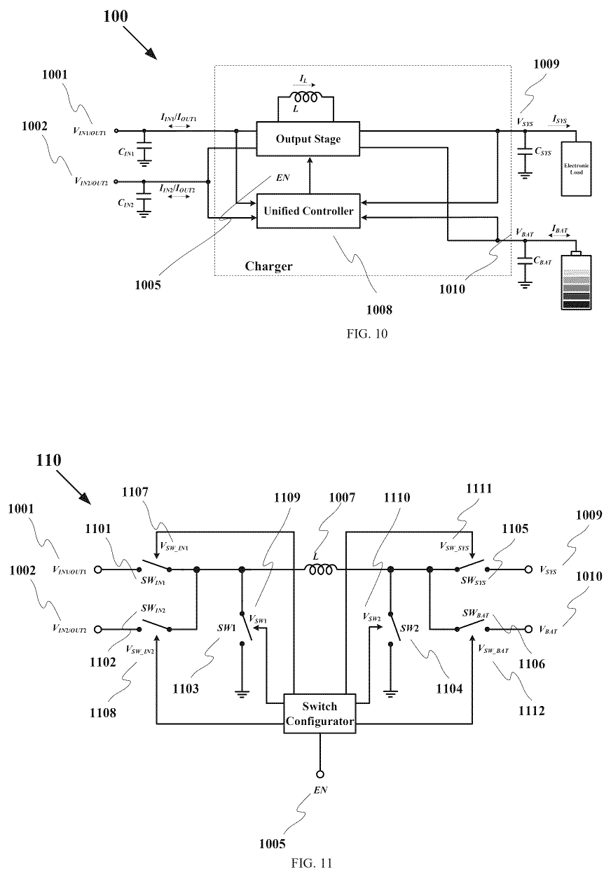

FIG. 10 depicts a switched-mode charger 100 according to a second exemplary embodiment of the invention with a control methodology or (unified) controller 1008. V_{IN1/OUT1} 1001 and V_{IN2/OUT2} 1002 are each configured to be connected to an energy source (or electronic load or energy storage devices). These energy sources include, but are not limited to, universal serial bus (USB) adaptors, embedded wireless power receivers, solar panels, energy harvesters, etc. This allows for combined higher current, voltage or both current and voltage (i.e., power) to power the electronic load and to charge the energy storage device. The control methodology or (unified) controller is connected to V_{IN1/OUT1} 1001 and V_{IN2/OUT2} 1002, an energy storage device connected to V_{BAT} 1010 and an electronic load connected to V_{SYS} 1009.

FIG. 11 depicts one embodiment of the output stage 110 for the second exemplary embodiment of the switched-mode charger invention in FIG. 10, wherein switching devices SW_{IN1} 1101, SW_{IN2} 1102, SW1 1103, SW2 1104, SW_{SYS} 1105 and SW_{BAT} 1106 can be implemented using any switching devices such as, but not limited to, transistors, diodes, etc. Based on the control signal, EN 1005, received, the output stage (by means of the switch configurator generates six control signals, V_{SW_IN1} 1107, V_{SW_IN2} 1108, V_{SW1} 1109, V_{SW2} 1110, V_{SW_SYS} 1111 and V_{SW_BAT} 1112, for turning ‘ON’ and ‘OFF’ the six switching devices, SW_{IN1} 1101, SW_{IN2} 1102, SW1 1103, SW2 1104, SW_{SYS} 1105 and SW_{BAT} 1106, respectively. Similar to FIG. 6, when the control signal, EN 1005, is at a high voltage level (or high state), the output stage of the switched-mode charger 100 is enabled, wherein the switch configurator produces pulses for turning on and off the six switching devices SW_{IN1} 1101, SW_{IN2} 1102, SW1 1103, SW2 1104, SW_{SYS} 1105 and SW_{BAT} 1106. The pulse width of the control signal EN 1005 is determined in some fashion (e.g., directly dependent) on a peak value of the current in the inductor, current I_{L}. The pulses define the six control signals V_{SW_IN1} 1107, V_{SW_IN2} 1108, V_{SW1} 1109, V_{SW2} 1110, V_{SW_SYS} 1111 and V_{SW_BAT} 1112. The width of each enabling signal portion typically (although not necessarily) corresponds to at least one complete charging cycle.

When two energy sources are connected to V_{IN1/OUT1} 1001 and V_{IN2/OUT2} 1002, two switching devices SW_{IN1} 1101 and SW_{IN2} 1102 respectively typically operate in a time-interleaved fashion, and there is one switch that is closed and hence one energy source that is connected to the switched-mode charger 100 at any one time. The timing of SW_{IN1} 1101 and SW_{IN2} 1102 can be determined by the electrical characteristics (e.g., available energy, output voltage, internal impedance, etc.) of each energy source or by the priority set by the users, and controlled by other means, e.g., a microcontroller. In other embodiments, both input switches SW_{IN1} 1101 and SW_{IN2} 1102 may be turned on at the same time so that both energy sources provide power to the outputs simultaneously. The pertinent operations of SW1 1103, SW2 1104, SW_{SYS} 1105 and SW_{BAT} 1106 are similar to that delineated earlier for FIGS. 7 and 8.

When a second electronic load and a second energy storage device are instead connected to V_{IN1/OUT1} 1001 and _{VIN2/OUT2} 1002, respectively, both inputs and outputs are, in some sense, symmetrical. Specifically, in one case, the second energy storage device connected to V_{IN2/OUT2} 1002 now powers the second electronic load connected to V_{IN1/OUT1} 1001 directly, and at the same time, powers the first electronic load connected to V_{SYS} 1009 and charges the first energy storage device connected to V_{BAT} 1010. In another case, the first energy storage device connected to V_{BAT} 1010 now powers the first electronic load connected to V_{SYS} 1009 directly, and at the same time, powers the second electronic load connected to V_{IN1} 1001 and charges the second energy storage device connected to V_{IN2} 1002. The pertinent operations of SW_{IN1} 1101, SW_{IN2} 1102, SW1 1103, SW2 1104, SW_{SYS} 1105 and SW_{BAT} 1106 are similar to that delineated earlier for FIGS. 7 and 8.

When a second and third energy storage devices are further instead connected to V_{IN1/OUT1} 1001 and V_{IN2/OUT2} 1002 respectively, the first energy storage device connected to V_{BAT} 1010 powers the electronic load connected to V_{SYS} 1009 directly, and at the same time, and charges the second and third energy storage devices connected to V_{IN1/OUT1} 1001 and V_{IN2/OUT2} 1002 respectively. The pertinent operations of SW_{IN1} 1101, SW_{IN2} 1102, SW1 1103, SW2 1104, SW_{SYS} 1105 and SW_{BAT} 1106 are similar to that earlier delineated for FIGS. 7 and 8.

Again FIG. 11 shows only one way of implementing the output stage, the interconnections with the inductor L 1007, and the various electronic loads, energy sources and energy loads. Depending on the applications and requirements, the output stage can be realized with more or fewer switching devices, and the interconnections between the switching devices and the inductor L 1007 may have many variations known to those skilled in the art. Also, in view of the different energy storage devices, the invention may involve boost converter/conversion.

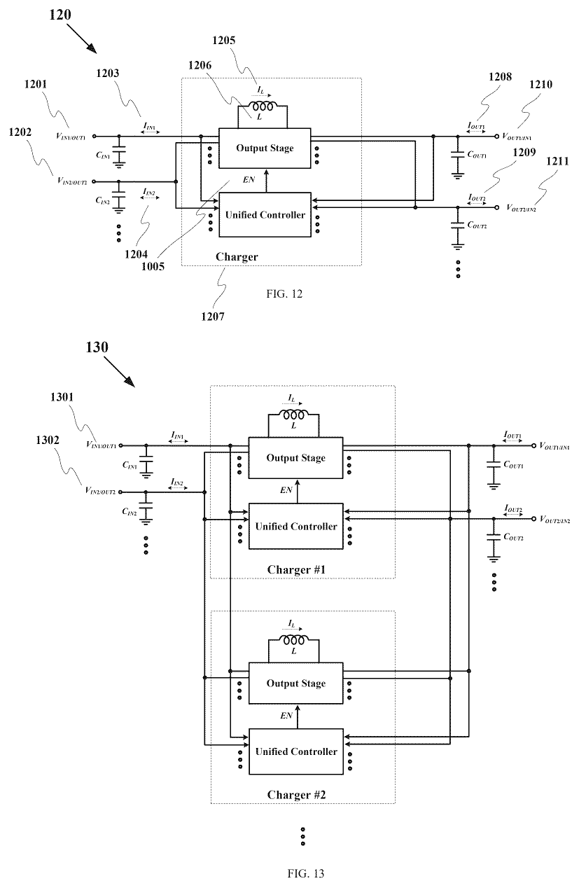

FIG. 12 depicts a switched-mode charger 120 according to a third exemplary embodiment of the invention with the control methodology or unified controller, whose V_{IN1/OUT1} 1201, V_{IN2/OUT2} 1202, etc. are configured to connected to multiple input ports including but not limited to electronic loads, energy storage devices, energy sources (e.g., solar panels) to, and whose V_{OUT1/IN1} 1210, V_{OUT2/IN2} 1211, etc. are configured to be connected to multiple output ports including but not limited to electronic loads, energy storage devices, energy sources (e.g. solar panels) respectively to V_{OUT1/IN1} 1210, V_{OUT2/IN2} 1211, etc. The switched-mode battery charger controls the bi-directional energy flows depending on the requirements, and may involve boost converter/conversion.

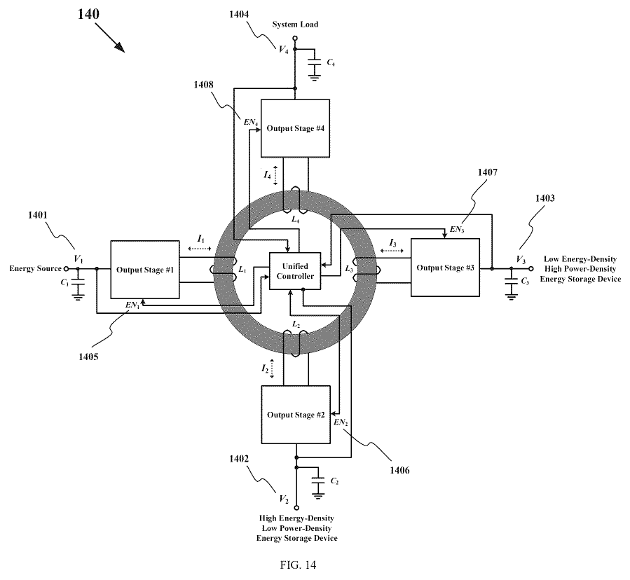

FIG. 13 depicts switched-mode charger 130 according to a fourth exemplary embodiment of the invention. This switched-mode charger includes multiple switched-mode chargers, where one switched-mode charger is depicted in FIG. 12. The outputs of the switched-mode chargers may be connected together. This switched-mode charger is configured to be connectable to multiple energy sources, V_{IN/OUT1} 1301, V_{IN/OUT2} 1302, etc., for powering multiple electronic loads and/or charging multiple energy storage devices at V_{IN/OUT1} 1301, V_{IN/OUT2} 1302, etc. Each switched-mode charger is self-regulated, and multiples of them may be arranged in parallel to output the combined current or power to V_{IN/OUT1} 1301, V_{IN/OUT2} 1302, etc.

FIG. 14 depicts a switched-mode charger 140 according to a fifth exemplary embodiment of the invention. The control methodology or (unified) controller is configured to have multiple ports of V₁ 1401, V₂ 1402, V₃ 1403, V₄ 1404, etc., by means of respective control signals, EN₁ 1405, EN₂ 1406, EN₃ 1407, EN₄ 1408, etc. All inputs and outputs ports are coupled together with an inductive coupler (e.g., transformer). Each port can be connected to an energy source (e.g., solar panels), an energy storage devices (e.g., battery, supercapacitor, etc.), or an electronic load. The (unified) controller is configured to control the bi-directional current flow for each port. Specifically, depending on the type of devices connecting to the port, the (unified) controller can control the current flowing into the port (hence the port is an output), or the current flowing out of the port (hence the port is an input).

As an example in FIG. 14, an energy source is connected to V₁ 1401, and a high energy-density low power-density energy storage device (e.g., Li-ion battery) is connected to V₂ 1402, and a low energy-density high power-density energy storage device (e.g., supercapacitor) is connected to V₃ 1403, and an electronic load is connected to V₄ 1404. When the energy source is available, it charges the two energy storage devices and powers the electronic load. In another case where the energy source is unavailable, the high energy-density low power-density energy storage device powers the electronic load and charges the low energy-density high power-density energy storage device when the electronic load is at low-power mode. In another case example, when the energy source is unavailable, the high energy-density low power-density energy storage device and/or low energy-density high power-density energy storage device powers the electronic load when the electronic load is at high-power mode. There are several other case examples and known to those skilled in the art.

FIG. 15 depicts one embodiment of the output stage 150 in FIG. 14, wherein switching devices SW1 1501, SW2 1502, SW3 1503, SW4 1504 and SW5 1505 can be implemented using any switching devices such as, but not limited to, transistors, diodes, etc. Based on the control signal, EN 1405,1406,1407 or 1408, received, the output stage generates five control signals, V_{SW1} 1506, V_{SW2} 1507, V_{SW3} 1508, V_{SW4} 1509 and V_{SW5} 1510, for turning ‘ON’ and ‘OFF’ the five switching devices, SW1 1501, SW2 1502, SW3 1503, SW4 1504 and SW5 1505, respectively. The control signal, EN, is a bi-level signal in a one or more of the charging phases. When the control signal, EN, is at a high voltage level, the output stage of the switched-mode charger is enabled, wherein the controller produces pulses for alternately turning on of the five switching devices, SW1 1501, SW2 1502, SW3 1503, SW4 1504 and SW5 1505, depending on that the port is an input or output, and also depending on that the port voltage is higher or lower than the reference.

The controller can be implemented in many ways known to those skilled in the art. One possible implementation is to use combinational logic, such as logic AND gates (not shown), with the control signal, EN, functioning as a gating signal at an input thereof to obtain the five control signals, V_{SW1} 1506, V_{SW2} 1507, V_{SW3} 1508, V_{SW4} 1509 and V_{SW5} 1510, at outputs of the logic AND gates. The pulse width of the control signal is determined based in some relation (including directly) to a peak value of an inductor current, I_{L}. The alternating pulses define the five control signals, V_{SW1} 1506, V_{SW2} 1507, V_{SW3} 1508, V_{SW4} 1509 and V_{SW5} 1510. The width of each enabling signal portion corresponds to at least one complete charging cycle.

Again, FIG. 15 depicts only one way of implementing the output stage and the interconnections with the inductor, L, in FIG. 14. Depending on the applications and requirements, the output stage can be realized with more or fewer switching devices, and the interconnections between the switching devices and the inductor L may have many variations known to those skilled in the art.

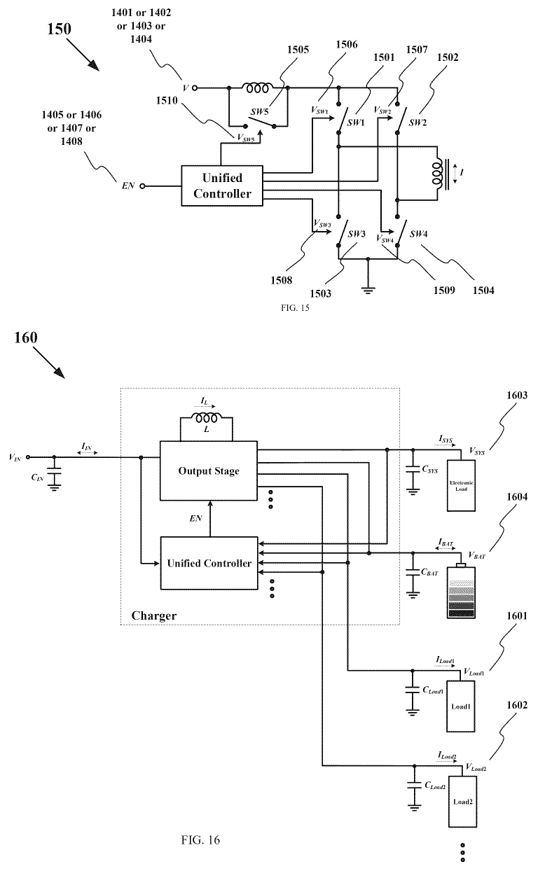

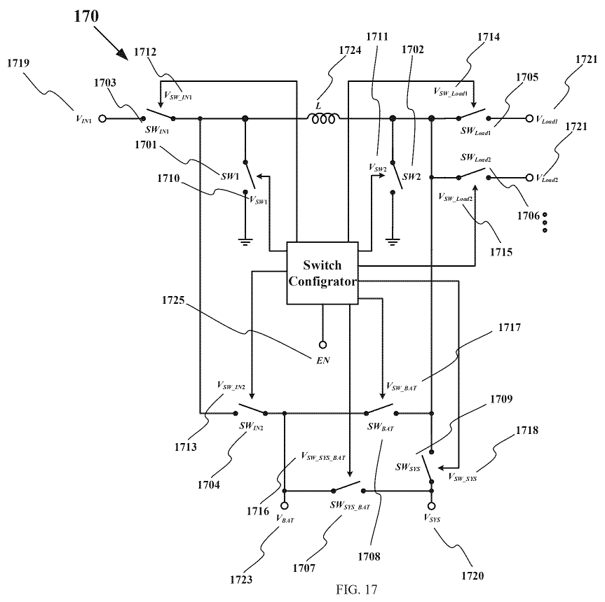

FIG. 16 depicts a switched-mode charger 160 according to a sixth exemplary embodiment of the invention. The control methodology or (unified) controller is configured to have one side being connected to an input port VIN for an energy source, and configured to have another side being connected to multiple output ports including loads (e.g., V_{Load1} 1601, V_{Load2} 1602, V_{SYS} 1603, etc.) and energy storage devices (e.g., V_{BAT} 1604). In particular, the (unified) controller is configured to control the bi-directional current flow for the ports connected to the energy storge devices.

FIG. 17 depicts one embodiment of the output stage 170 in FIG. 16, wherein SW1 1701, SW2 1702, SW_{IN1} 1703, SW_{IN2} 1704, SW_{LOAD1} 1705, SW_{LOAD2} 1706, SW_{SYS_BAT} 1707, SW_{BAT} 1708, and SW_{SYS} 1709 can be implemented using any switching devices such as, but not limited to, transistors, diodes, etc. Based on the control signal, EN 1725, received, the output stage generates pertinent control signals V_{SW1} 1710, V_{SW2} 1711, V_{SW_IN1} 1712, V_{SW_IN2} 1713, V_{SW_LOAD1} 1714, V_{SW_LOAD2} 1715, V_{SW_SYS_BAT} 1716, V_{SW_BAT} 1717, and V_{SW_SYS} 1718 for turning ‘ON’ and ‘OFF’ the switching devices SW1 1701, SW2 1702, SW_{IN1} 1703, SW_{IN2} 1704, SW_{LOAD1} 1705, SW_{LOAD2} 1706, SW_{SYS_BAT} 1707, SW_{BAT} 1708, and SW_{SYS} 1709, respectively. The control signal, EN 1725, is a bi-level signal in one or more of the charging phases. When the control signal, EN 1725, is at a high voltage (or high state) level, the output stage of the switched-mode charger 160 is enabled, wherein the controller produces pulses for alternately turning on and off the switching devices SW1 1701, SW2 1702, SW_{IN1} 1703, SW_{IN2} 1704, SW_{LOAD1} 1705, SW_{LOAD2} 1706, SW_{SYS_BAT} 1707, SW_{BAT} 1708, and SW_{SYS} 1709. When V_{IN1} 1719 is connected to an energy source, the energy from the energy source is transferred to the multiple output voltage ports (e.g., V_{SYS} 1720, V_{Load1} 1721, V_{Load2} 1722, etc.) and to an energy storage device (V_{BAT} 1723), via the inductor, L 1724, and pertinent switching devices. When V_{IN1} 1719 is disconnected from the energy source, the charged energy storage device can serve to transfer the stored energy from V_{BAT} 1723 to the multiple output voltage ports (e.g., V_{SYS} 1720, V_{Load1} 1721, V_{Load2} 1722,, etc.) The (unified) controller can be implemented in many ways known to those skilled in the art.

FIG. 17 depicts only one way of implementing the output stage and the interconnections with the inductor, L 1724, in FIG. 16. Depending on the applications and requirements, the output stage can be realized with more or fewer switching devices, and the interconnections between the switching devices and the inductor L may have many variations known to those skilled in the art.

The switched-mode chargers shown in FIG. 4, FIG. 10, FIG. 12, FIG. 13, FIG. 14 and FIG. 16 may operate in a first operation mode as described above where the energy source is used to power electronic loads and/or to charge the energy storage devices. In other embodiments, each switched-mode charger may be configurable for bi-directional charging. Specifically, the switched-mode charger may be configured to operate in a second operation mode when there is a need to transfer energy from the energy storage device(s) depicted on the right to the energy source(s) depicted on the left of the pertinent figures. The (unified) controller can be configured to control the direction of energy flow accordingly. In the second operation mode, the configuration can be realized by sensing the input voltage, V_{IN} or V_{IN/OUT}, instead of the output voltage, V_{OUT} or V_{OUT/IN}, as described above for generating the control signal. The control methodology described above for the switched-mode chargers shown in FIG. 4, FIG. 10, FIG. 12, FIG. 13, FIG. 14, and FIG. 16 remains mostly unchanged. To provide this bi-directional charging, the control circuitry generates the same control signal that includes enabling and disabling signal portions that are based on a voltage at the input instead.

Note that because of the flexibility of the invention, there are other operation modes, and these would be known to persons skilled in the art.

Accordingly, each of the above-described switched-mode chargers implements a method of charging one or more energy storage devices. The method includes generating a control signal that includes enabling and disabling signal portions that are based on a voltage of an energy storage device being charged.

The control signal alternately charges and discharges the inductor during the enabling signal portions of the control signal, and reduces the inductor current (low current, including zero current) during the disabling signal portions of the control signal.

The control signal may be set high for a first duration when the voltage of the energy storage device is lower than a first threshold, and for a second duration when the voltage of the energy storage device is higher than the first threshold. The second duration may be longer or shorter than the first duration.

The control signal may be set high for the second duration when the voltage of the energy storage device is higher than the first threshold and lower than a second threshold, and for a third duration when the voltage of the energy storage device is higher than the second threshold and lower than a third threshold. The third duration may be close to or for all time.

The third threshold may be close to or is a maximum voltage of an energy storage device. The control signal may be set high at a shorter duration when the voltage of the energy storage device reaches the third threshold.

The width of each enabling signal portion corresponds to one or more complete operating cycles of coupling the energy storage device to the energy source and then to the ground.

In some embodiments, the energy source is at least one energy source selectable from multiple energy sources.

And in some embodiments, the energy storage device is at least one energy storage devices selectable from multiple energy storage devices.

Although the present invention is described as implemented in the above-described embodiments, it is not to be construed to be limited as such. For example, although it is described that there are four separate charging phases, there may be more or less than four charging phases.

Whilst there has been described in the foregoing description exemplary embodiments of the present invention, it will be understood by those skilled in the technology concerned that many variations and combination in details of design, construction and/or operation may be made without departing from the present invention.

### REFERENCE

[U.S. Pat. No. 9,099,919] Jing et al., SINGLE-INDUCTOR-MULTIPLE-OUTPUT REGULATOR WITH SYNCHRONIZED CURRENT MODEHYSTERETC CONTROL, Aug. 4, 2015.

[U.S. Pat. No. 8,624,429] SINGLE-INDUCTOR-MULTIPLE-OUTPUT REGULATOR WITH AUTO-HOPPING CONTROLAND THE METHOD OF USE, Jan. 7, 2014.

1. A device comprising at least one charging circuit, wherein the at least one charging circuit comprises:
at least one input for connecting to at least one energy source;
at least one output
for connecting to at least one load, and
having an output voltage;
a controller configured to generate a control signal having
an enabling signal portion, or
a disabling signal portion, or
both an enabling signal portion and a disabling signal portion,
wherein
the enabling signal portion or the disabling signal portion is related to
the output voltage; and
an output stage configured to:
during the enabling signal portion, couple an inductor to
the at least one input, or
the at least one output, or
both the at least one input and the at least one output; and
during the disabling signal portion, isolate the inductor from
the at least one input, or
the at least one output, or
both the at least one input and the at least one output.

2. The device according to claim 1, wherein the at least one charging circuit further comprises at least another output
for connecting to at least another load, and having another output voltage; and
the enabling signal portion or the disabling signal portion is related to
the output voltage, or
the another output voltage, or
both the output voltage and the another output voltage.

3. The device according to claim 2, wherein the at least one load and the at least another load are one or a combination of the following:
an electronic load,
an energy source, or
an energy storage device.

4. The device according to claim 3, wherein
the energy storage device has a first threshold voltage, and
the duration of the enabling signal portion is adaptively adjusted to maintain one or a combination of the following:
a constant voltage of either the output voltage or the another output voltage
or both the output voltage and the another output voltage, or
a constant current to the at least one load, or to the at least another load, or to both the at least one load and the at least another load when the output voltage or the another output voltage is lower than the first threshold voltage.

5. The device according to claim 4, wherein
the energy storage device further has a second threshold voltage, and
the duration of the enabling signal portion is adaptively adjusted to maintain a constant current to the at least one load, or to the at least another load, or to both the at least one load and the at least another load when the output voltage or the another output voltage is higher than the first threshold voltage and lower than the second threshold voltage.

6. The device according to claim 3, wherein
the energy storage device further has a second and third threshold voltage, and
the duration of the enabling signal portion is adaptively adjusted to further maintain
a variable or constant voltage of
the output voltage, or
the another output voltage, or
both the output voltage and the another output voltage, or
a constant current, when the output voltage or the another output voltage is higher than the second threshold voltage and lower than the third threshold voltage, to
the at least one load, or
the at least another load, or
both the at least one load and the at least another load

7. The device according to claim 3, wherein
the energy storage device further has a third threshold voltage, and when the output voltage or the another output voltage is higher than the third threshold voltage, the duration of the enabling signal portion is adaptively adjusted to further maintain
a constant voltage of the output voltage connected to the at least one load, and
either as a constant voltage or variable voltage of the another output voltage to the at least another load.

8. The device according to claim 1, wherein there is at least one cycle of charging and discharging of inductor current during the enabling signal portion.

9. The device according to claim 1, wherein either the peak, the valley or both the peak and the valley of inductor current is adaptively adjusted to maintain either
a constant current to the at least one load, or
a constant or variable voltage at the output voltage connected to the at least one load.

10. The device according to claim 3 having at least another input, wherein
the energy source is connected to the at least one input, and
another energy source is connected to the at least another input.

11. The device according to claim 3, wherein
the at least one output is connected to the energy storage device,
the at least one input is instead connected to another energy storage device, and
the energy storage device charges the another energy storage device.

12. The device according to claim 11, wherein
the output stage comprises
a plurality of input switches, and
a plurality of output switches,
the electronic load is connected to the at least another output, and
the plurality of output switches comprises first, second, and third switches,
wherein
the first switch is configured to couple the electronic load to the energy storage device,
the second output switch is configured to couple the electronic load to the energy source; and
the third switch is configured to couple the energy storage device to either energy source or to the another energy source.

13. The device according to claim 12, wherein the coupling by either the first switch, second switch or third switch includes the coupling of the inductor.

14. The device according to claim 3, wherein
the device further comprises at least another charging circuit having at least one output, and
the at least one output of the at least charging circuit is coupled to the at least one output of the at least another charging circuit.

15. The device according to claim 1, wherein the device further comprises
at least another charging circuit having at least one output, and
a coupled inductor or a transformer, and
the at least one output of at least charging circuit is coupled to the at least one output of the at least another charging circuit via the coupled inductor or the transformer.

16. The device according to claim 15, wherein the controller is configured to generate control signals for at least one charging circuit and for the at least another charging circuit.

17. The device according to claim 15, wherein
the at least one output of the at least another charging circuit is connected to an energy storage device, and
the energy storage device charges the at least one load or the at least one energy source.

18. The device according to claim 17, wherein
the at least another charging circuit comprise at least one input connected to at least one load, and
the energy storage device further charges the at least one load connected to the at least one input of the at least another charging circuit.

19. The device according to claim 1, wherein an average current in the inductor is adaptively adjusted to maintain a constant or variable voltage of the output voltage.

20. A method for charging by a charging circuit having a first terminal connected to an energy source, a second terminal connected to an electronic load, a third terminal connected to an energy storage device, an inductor, and a controller, the method comprising:
generating, by the controller, a control signal related to the output voltage, to regulate the current in the inductor, wherein the control signal has an enabling signal portion and a disabling signal portion;
during the enabling signal portion, coupling the first terminal via the inductor to the second terminal, the third terminal, or both the second terminal and the third terminal; and
during the disabling signal portion, uncoupling the first terminal from the second terminal and the third terminal.
